(19) United States
(12) Patent Application Publication
(10) Pub. No.: US 2017/0167853 A1
(43) Pub. Date: Jun. 15, 2017

(54) DRILLING EQUIPMENT POSITION MEASUREMENT SYSTEM AND METHOD

(71) Applicant: Schlumberger Technology Corporation, Houston, TX (US)

(72) Inventors: Shunfeng Zheng, Katy, TX (US); Vishwanathan Parmeshwar, Houston, TX (US)

(21) Appl. No.: 14/983,298

(22) Filed: Dec. 29, 2015

Related U.S. Application Data
(60) Provisional application No. 62/265,499, filed on Dec. 10, 2015.

(51) Int. Cl. G01B 11/04; E21B 19/00; E21B 19/06

(52) U.S. Cl. CPC G01B 11/043; E21B 19/06; E21B 19/008

(57) ABSTRACT

An elevation measurement system for a drilling rig and method. The method includes obtaining a first measurement of a first position of a tubular handling assembly using a detector, and moving the tubular handling assembly after obtaining the first measurement. The detector is configured to continuously detect a current position of the at least a portion of the tubular handling assembly while moving the tubular handling assembly. The method also includes obtaining a second measurement of a second position of the tubular handling assembly using the detector, and determining a length of a tubular string based partially on a difference between the first and second positions.

### CROSS-REFERENCE TO RELATED APPLICATIONS

This application claims priority to U.S. Provisional Patent Application having Ser. No. 62/265,499, which was filed on Dec. 10, 2015 and is incorporated herein by reference in its entirety.

### BACKGROUND

In drilling operations, the length of the drill string may be monitored and updated by various instruments. Maintaining an accurate and generally up-to-date measure of the drill string length may have a variety of uses. For example, knowledge of the drill string length may facilitate maintaining operational safety. If drilling depth is not tracked properly, a driller may run the whole drill string into the rock at an accelerated rate without realizing the bottom end of the hole is approaching, potentially causing severe equipment damage and operational problems.

Another use is for depth correlation. For example, a specific target (e.g., a reservoir) may have a certain depth, or a kick-off point for a deviated section of a well may be specified in terms of drilling depth. Drill string length may be used as a proxy for the drilling depth, and thus, a drilling operator may recognize that such an event has occurred (or is to occur) when a certain string length is reached. Further, recorded event occurrences, logs, etc. may be linked to drilling depth through drill string length, which may provide insight into the subterranean formation properties.

Generally, drill string length is measured using an encoder at the drawworks of the rig. In many rigs, the drawworks is a winch that controls the raising and lowering of the travelling block, which in turn adjusts the elevation of the drilling device such as a top drive or kelly and the drill string attached thereto. The encoder records the revolutions of the drum of the drawworks, which in turn provides the distance that the travelling block has been lowered. When a stand is fully deployed, the block can be raised again using the drawworks, and the process can be repeated.

However, the drawworks encoder measurement may have an inherent error caused by the radius of the layer of drill line relative to the center of the drawworks, the stretch of drill line under the hookload (which itself may fluctuate, e.g., by downhole pressures, etc.), and the like. Accordingly, a geolograph line is sometimes be used to calibrate the drawworks encoder. The geolograph line is a cable that is attached directly to the drilling device or the travelling block. A cable retrieval system for the cable is provided, along with an encoding sensor, and both are attached to a fixed point on or near the rig floor. The geolograph line then travels up and down the derrick with the drilling device while the encoder measures the amount of line being paid out or retrieved. However, the measurements taken by the drawworks, even as calibrated by the geolograph line, may carry a large error and thus uncertainty in the depth measurement.

### SUMMARY

Embodiments of the disclosure may provide a method including obtaining a first measurement of a first position of a tubular handling assembly using a detector, and moving the tubular handling assembly after obtaining the first measurement. The detector is configured to continuously detect a current position of the at least a portion of the tubular handling assembly while moving the tubular handling assembly. The method also includes obtaining a second measurement of a second position of the tubular handling assembly using the detector, and determining a length of a tubular string based partially on a difference between the first and second positions.

Embodiments of the disclosure may also provide an elevation measurement system for a drilling rig. The system includes a tubular handling assembly including a drilling device that is movable along an axis and connectable to a tubular, and a detector coupled to the tubular handling assembly or to the drilling rig, the detector being configured to continuously determine a position or a position change of the tubular handling assembly.

It will be appreciated that the foregoing summary is intended merely to introduce a subset of the features described in greater detail below, and is not intended to be exhaustive or to limit the scope of the disclosure.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a drilling rig and a control system, according to an embodiment.

FIG. 2 illustrates a schematic view of a drilling rig and a remote computing resource environment, according to an embodiment.

FIG. 3 illustrates a schematic view of a drilling rig including an elevation measurement system, according to an embodiment.

FIG. 4 illustrates a schematic view of the elevation measurement system, according to an embodiment.

FIG. 5 illustrates a schematic view of the elevation measurement system, according to another embodiment.

FIG. 6 illustrates a schematic view of the elevation measurement system, according to yet another embodiment.

FIG. 7 illustrates a simplified, perspective view of the drilling rig including the elevation measurement system, according to another embodiment.

FIGS. 8A and 8B illustrate a schematic view of an example of an operation of the detector, according to an embodiment

FIG. 9 illustrates a perspective view of the drilling rig including the elevation measurement system, according to another embodiment.

FIG. 10 illustrates a schematic view of an array of detectors of the elevation measurement system of FIG. 9, according to an embodiment.

FIG. 11 illustrates a perspective view of the drilling rig including the elevation measurement system, according to yet another embodiment.

FIG. 12A illustrates a schematic view of one of the guide rails of the drilling rig of FIG. 11 and another elevation depth measurement system, according to an embodiment.

FIG. 12B illustrates an enlarged view of a portion of FIG. 12A, showing a first assembly of the elevation measurement system thereof, in greater detail, according to an embodiment.

FIG. 12C illustrates an enlarged view of another portion of FIG. 12A, showing a second assembly of the elevation measurement system thereof, in greater detail, according to an embodiment.

FIG. 13 illustrates a flowchart of a method for tracking a length of a tubular string, according to an embodiment.

FIGS. 14A and 14B illustrate simplified schematic views of tubular string and a new stand during an execution of the method, according to an embodiment.

FIG. 15 illustrates a schematic view of a computing system, according to an embodiment.

### DETAILED DESCRIPTION

Reference will now be made in detail to specific embodiments illustrated in the accompanying drawings and figures. In the following detailed description, numerous specific details are set forth in order to provide a thorough understanding of the invention. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object or step, and, similarly, a second object could be termed a first object or step, without departing from the scope of the present disclosure.

The terminology used in the description of the invention herein is for the purpose of describing particular embodiments only and is not intended to be limiting. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

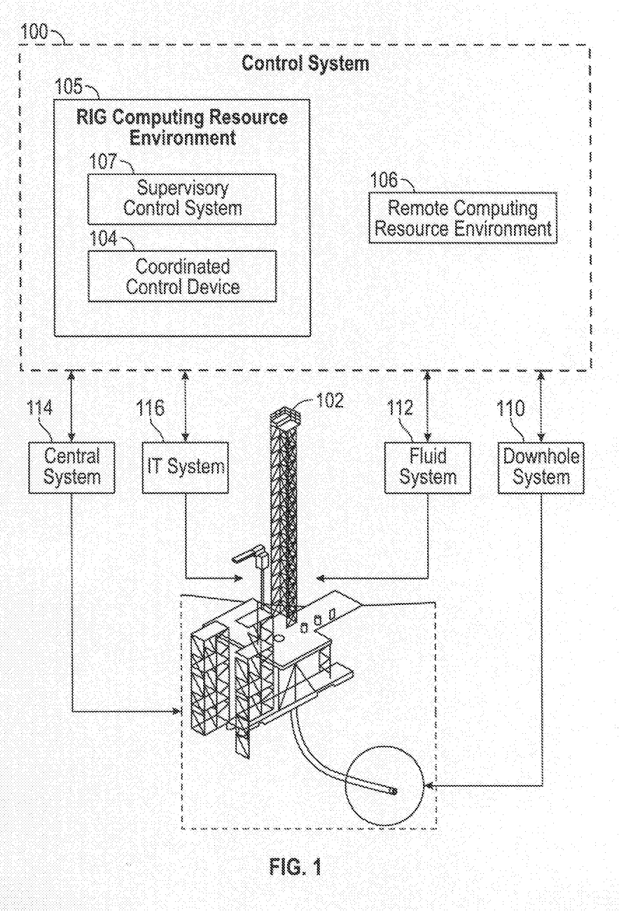

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

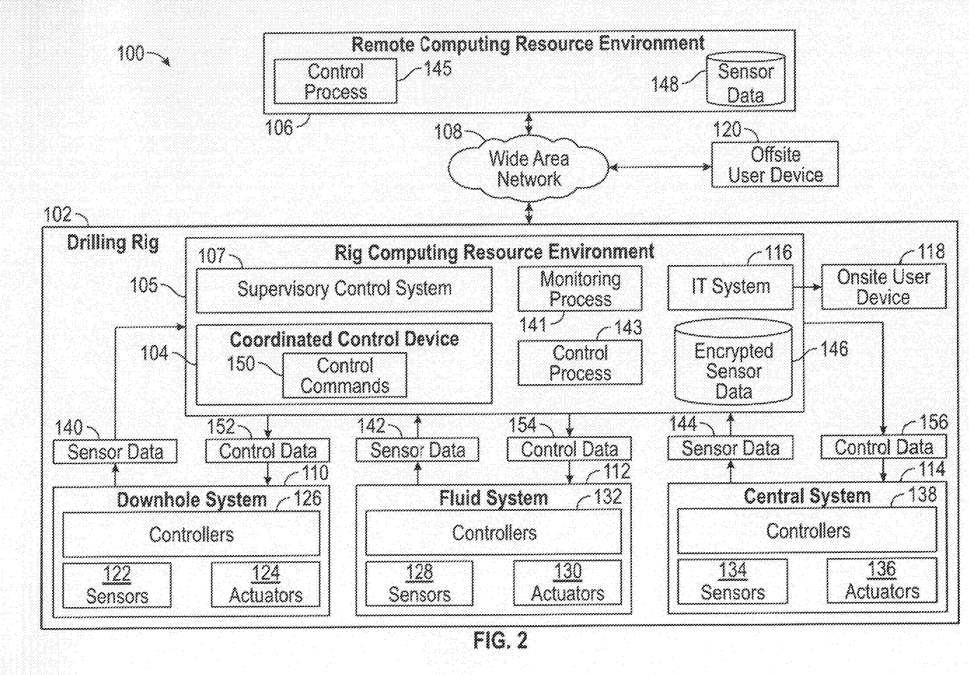

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

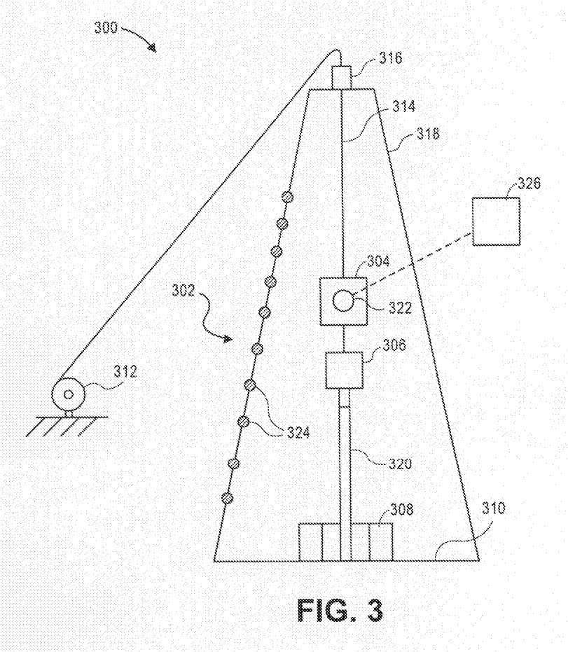

FIG. 3 illustrates a schematic view of a drilling rig 300 including an elevation measurement system (hereinafter, “the system”) 302, according to an embodiment. The drilling rig 300 may include a tubular handling assembly, including, for example, a travelling block 304 and a drilling device 306. Thus, referring to the position of the tubular handling assembly may refer to a position determined for any one or more components thereof, e.g., the travelling block 304 and/or the drilling device 306. Similarly, referring to a position of “at least a portion of” the tubular handling assembly may refer to a position determined for any one or more components thereof, e.g., the travelling block 304 and/or the drilling device 306.

The drilling device 306 may be a top drive, kelly, or any other structure capable of rotating and deploying a tubular as part of a tubular string into a wellbore may be employed. The rig 300 may also include a slips assembly 308 disposed at a rig floor 310. The drilling device 306 may be vertically movable by moving the travelling block 304. In turn, the travelling block 304 may be vertically movable by a rotation of a drawworks 312 that is connected the travelling block 304 via a drill line 314. As the drawworks 312 is rotated, the drill line 314 is reeled in or let out, thereby adjusting the position of the travelling block 304. The drill line 314 may be connected to the travelling block 304 via a crown block 316 located at a top of a rig structure 318 (e.g., a derrick). One of ordinary skill in the art will recognize that various other features of a drilling rig 300 may be present, although not shown in this simplified, schematic illustration.

The drilling rig 300 may be operative to deploy a tubular (e.g., drill) string 320 into a wellbore below. In some embodiments, the drilling rig 300 may be configured to incrementally run stands of tubulars (e.g., singles, doubles, triples, etc.). In such an operation, the slips assembly 308 may support the tubular string 320, while a pipe handling device (e.g., manipulator arm, elevator, etc.) brings a new stand into position, and the new stand is attached to the drilling device 306, e.g., by rotation of the shaft of the drilling device 306. The new stand may then be lowered into contact with the string 320, and rotated (e.g., by the drilling device 306, or another device such as tongs) so as to connect the new stand with the string 320, upon which the new stand is considered part of the string 320. The slips assembly 308 may then release the string 320, such that the string 320 is supported by the drilling device 306. The drilling device 306 may then be employed to rotate the string 320, and the string 320 may be lowered by lowering the travelling block 304 by operation of the drawworks 312.

The system 302 may include a detector 322, which may be coupled to the travelling block 304, as shown, or to the drilling device 306. The detector 322 may be movable by moving the travelling block 304. The form of the detector 322 may vary depending on the embodiment of the system 302, as will be appreciated from the following description of several example embodiments thereof. In the illustrated embodiment, the detector 322 may be an optical sensor, such as a camera, which may be configured to detect and distinguished between markers 324 of the system 302. The markers 324 may be positioned along the rig structure 318, which may be “stationary” with respect to the moving drilling device 306 and may be “permanent” in that the markers 324 are retained in position at least as long as drilling operations are conducted. Further, the markers 324 may be disposed at predetermined elevations (e.g., generally uniform elevation intervals). In some embodiments, the markers 324 may be connected directly to the rig structure 318, or may be connected to a separate structure, which may in turn be connected to the rig structure 318. Either such embodiment is within the scope of the term “coupled to.”

Accordingly, as the travelling block 304 (and/or drilling device 306) moves, the detector 322 may be configured to detect one of the markers 324 that corresponds to the elevation of the travelling block 304 above the rig floor 310. For example, the detector 322 may capture an image of the marker 324, which may be unique among the markers 324. The detector 322 may transmit such an image to a controller 326, which may be or be included within the rig control system 100 discussed above. The controller 326 may include one or more computer processors, and may be provided with image-recognition software configured to identify the marker 324 from the image captured by the detector 322. In another embodiment, the detector 322 may include hardware to distinguish the marker 324, and may transmit data identifying the marker 324, or an elevation associated therewith, rather than the image itself. In some embodiments, however, the controller 326 may employ the identification of the marker 324 to determine the elevation of the travelling block 304. This may allow the controller 326 to maintain an accurate log of the length of the tubular string 320, and, in some embodiments, to determine the length of the tubular string 320 while a new stand is being run.

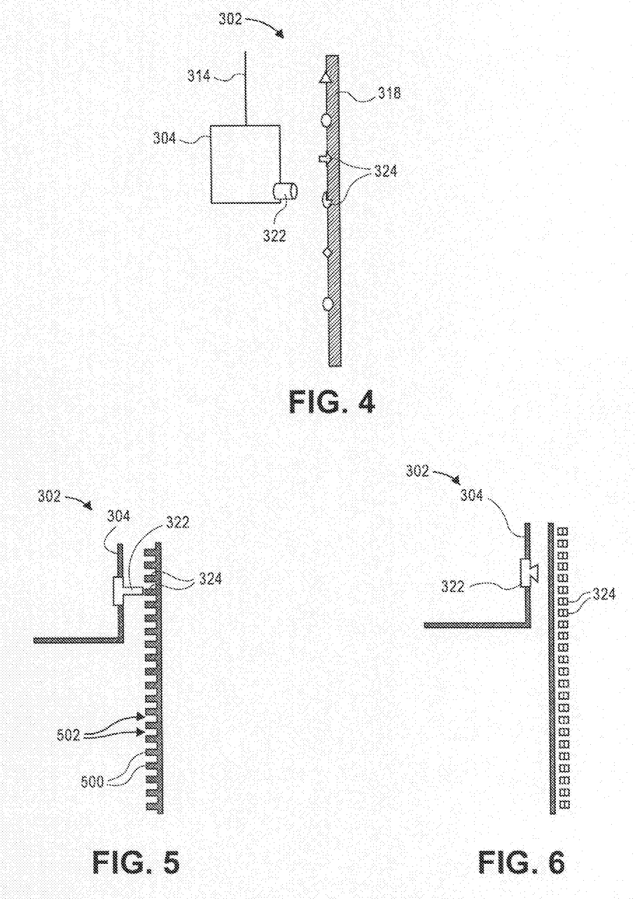

FIG. 4 illustrates a schematic view of the system 302, according to an embodiment. As shown, the detector 322 may be coupled to the travelling block 304, which may be movable via the drill line 314. The detector 322 may be an optical sensor, such as a camera.

The markers 324 may be positioned in a linear fashion, e.g., vertically from the rig floor 310. Further, each marker 324 may have a distinct feature, which may allow it to be distinguished from the neighboring markers 324. For example, as illustrated, each marker 324 may have a different shape. In another embodiment, each marker 324 may bear a number, which may be sequential, representative of elevation (e.g., similar to a ruler), and/or the like. Further, the markers 324 may be positioned at any interval, e.g., every millimeter, every second millimeter, etc.

FIG. 5 illustrates a schematic view of the system 302, according to another embodiment. In this embodiment, the stationary markers 324 may include teeth 500 separated by slots 502. The teeth 500 may be made of a ferrous material, and the detector 322 may be a magnetic sensor. Similar in operation to an encoder, when the detector 322 passes one of the teeth 500 as the travelling block 304 moves upward, the detector 322 may measure a pulse or disruption in a magnetic field caused by the proximity to the tooth 500 (or the slot 502). The teeth 500 may be disposed at uniform intervals, and the detector 322 (or the controller 326, FIG. 3) may count the pulses in order to determine the elevation of the travelling block 304 and/or the drilling device 306.

FIG. 6 illustrates a schematic view of the system 302, according to yet another embodiment. In this embodiment, the markers 324 may include unique, color-coded images. The color-coding may, for example, be provided in lieu of or in addition to unique shapes, numbers, etc. Further, the detector 322 may be a camera, and may be capable of distinguishing multiple colors from one another. Thus, for example, with a color scheme of 256 potential colors (as merely a representative example, color schemes of many more colors are contemplated), may provide 256 unique identifiers for the markers 324. Moreover, the markers 324 may provide a combination of two or more colors, thus exponentially increasing the number of unique identifiers for the markers 324. The color scheme may be converted to a number, for example, by the controller 326. The number, in turn, may be associated with a particular, predetermined elevation of the markers 324, e.g., in a database.

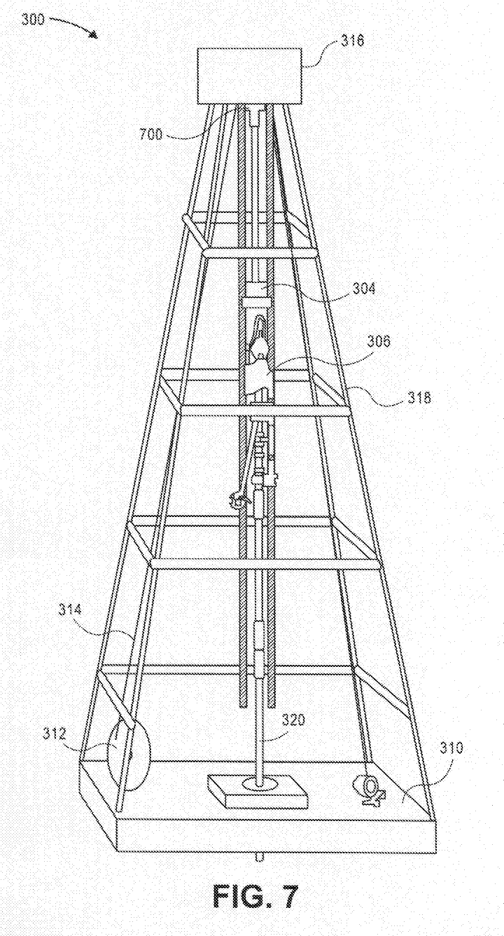

FIG. 7 illustrates a simplified, perspective view of the drilling rig 300, according to another embodiment. The drilling rig 300 may include a detector 700, e.g., instead of or in addition to the detector 322 (e.g., FIG. 3), as part of the system 302 (e.g., FIG. 3). The detector 700 may be positioned at the top of the rig structure 318, e.g., near and/or coupled to the crown block 316. For example, the detector 700 may be a still or video camera positioned at the crown block 316, oriented downward, such that the camera is configured to capture an image of the top of the travelling block 304.

The detector 700 may be configured to determine an elevation of the travelling block 304. Since the elevation of the detector 700 may be fixed and predetermined, the elevation of the travelling block 304 (and/or the drilling device 306) may be calculated when the distance between the travelling block 304 and the detector 700 is measured. In some embodiments, this may be a continuous “real-time” measurement (e.g., with a sampling frequency high enough that a human user may not experience at appreciable wait-time between measurements), a measurement taken at routine intervals, or an on-demand measurement, e.g., at the discretion of a human operator.

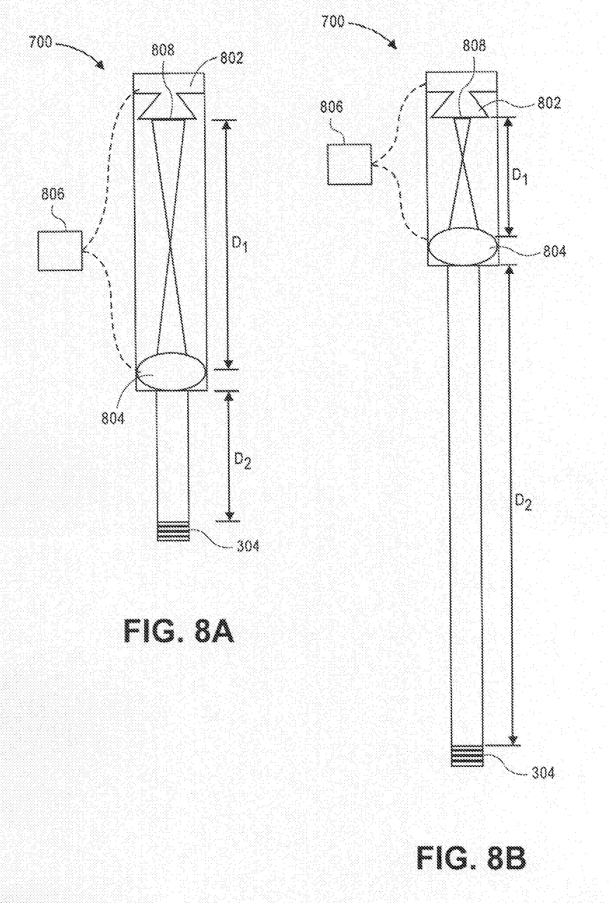

With continuing reference to FIG. 7, FIGS. 8A and 8B illustrate schematic views of an example of an operation of the detector 700, according to an embodiment. In this embodiment, the detector 700 may include an image sensor 802 and an adjustable-position lens 804. A controller 806, which may be part of the controller 326 (FIG. 3) of the detector 700 may be configured to adjust the position of the lens 804 with respect to the image sensor 802. The controller 806 may also be configured to detect and recognize shape. The detector 700 may be locked on to the image of the top of the travelling block 304, which may include a top view of one or more pulleys.

As the travelling block 304 moves, the controller 806 adjusts the position of the lens 804 to adjust the focus. For example, the controller 806 may be configured to maintain the image of the travelling block 304 below “in focus,” which may be automatically determined by any suitable image-processing technique.

Further, the pixel size of an image 808 captured by the sensor 802 may depend at least partially upon the focal length and the distance of the travelling block 304 from the detector 700. As the top of the travelling block 304 moves away from the detector 700, the effective pixel size of the travelling block 304 in the image 808 thus reduces. The controller 806 may, however, be configured to adjust a distance D1 between the lens 804 and the sensor 802, in order to both maintain focus and pixel size of the image 808. As such, this distance D1 may be indirectly proportional to a distance D2 between the detector 700 and the travelling block 304. The controller 806 may be provided with this relationship, and by measuring the distance D1, may be configured to determine the distance D2. As noted above, with the distance D2 between the detector 700 and the travelling block 304 determined, the elevation of the travelling block 304 may be calculated.

In another example, the controller 806 may set the block image 808 pixel size and shape constant at a first distance from the detector 700. As the travelling block 304 starts to move away from the detector, the controller 806 activates the zoom feature (e.g., adjusts the zoom by moving the lens 804, e.g., away from the sensor 802) to keep the block image 808 pixel size constant. The amount of zoom employed to maintain the block image 808 at the same pixel size, that is, the distance D1, may be directly proportional to the distance D2 of the travelling block 304 to the detector 700. Thus, the distance D2 may thus be calculated based on the zoom used and a reference distance D2 for a given size of the image 808. Further, the aperture of the detector 700 may be modulated to get a wider depth of field while zooming, e.g., to maintain the image 808 generally in focus.

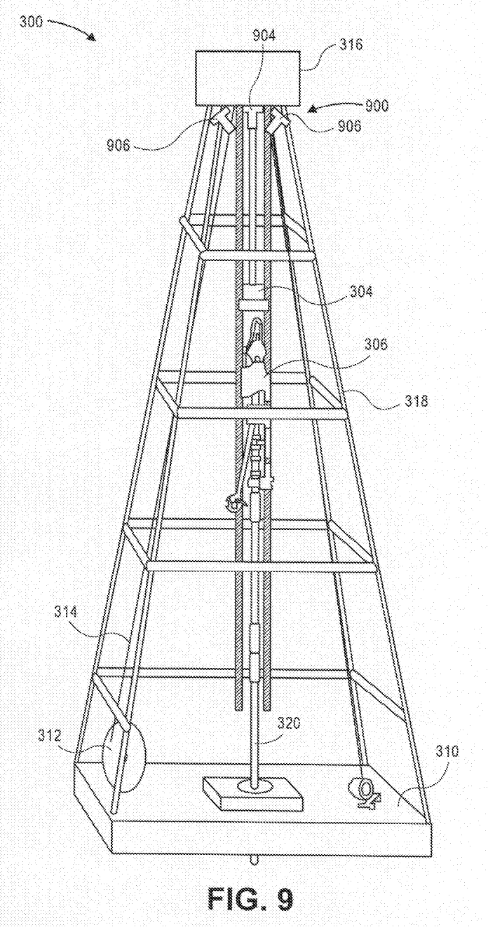

FIG. 9 illustrates a perspective view of the drilling rig 300, according to still another embodiment. The drilling rig 300 may include an array of detectors 900, in lieu of or in addition to the detector 322 and/or the detector 700, thereby providing at least a portion of another elevation measurement system. The array of detectors 900 may be disposed proximal to the top of the rig structure 318, e.g., coupled to the crown block 316. In an embodiment, the array of detectors 900 may include one or more cameras (three shown: 902, 904, 906). The cameras 902, 904, 906 may be pointed downwards, so as to capture an image of the top of the travelling block 304. Further, the cameras 902, 904, 906 may be offset with respect to one another, but may have an overlapping or the same field of view, thereby providing different perspectives for the same image.

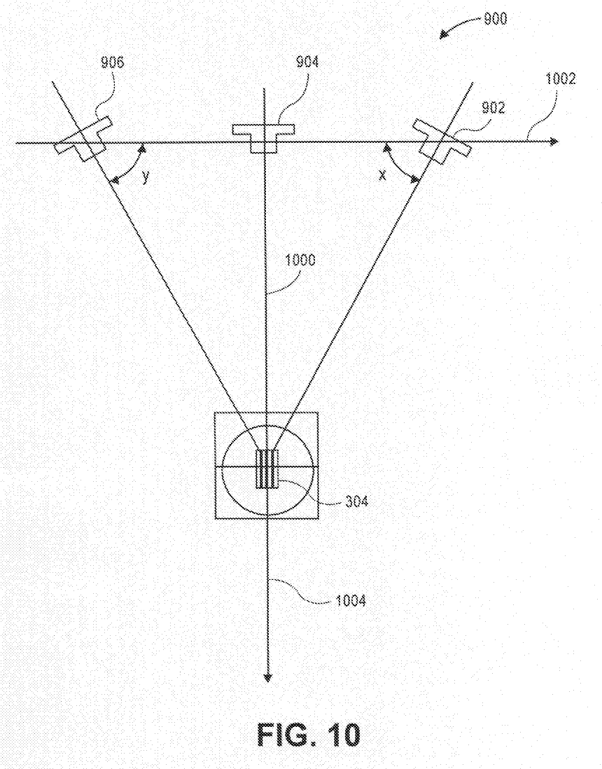

With continuing reference to FIG. 9, FIG. 10 illustrates a schematic view of the array of detectors 900, according to an embodiment. The array of detectors 900, as shown in this example, includes the three cameras 902, 904, 906, oriented, e.g., downwards, so as to point toward the travelling block 304. Again, the image of the top of the travelling block 304 is represented schematically as pulleys.

In this embodiment the center video camera 904 may be aligned at the vertical central plane 1000 of the travelling block 304. The other two video cameras 902, 906 may be placed at predetermined distance from the central video camera 904 along a reference axis 1002. The central video camera 904 may determine the pixel size of the image 808 of the travelling block 304 and the position in the field of view, while the two other video cameras 902, 906 may be adjusted such that the images match the image with captured by the central video camera 904.

The video cameras 902, 906, kept at the predetermined distance from the central camera 904, may be mounted on a swivel, so that angles x and y of the video cameras 902, 906, may be adjustable. The angle x and y may be defined between the direction in which the camera 902, 906 is pointed (i.e., toward the travelling block 304) and the reference axis 1002 (e.g., horizontal) that is normal to an axis 1004 (e.g., vertical) in which the travelling block 304 moves. The axis 1004 may be in the central plane 1000 in some embodiments. The angles x and y may be measured and controlled (e.g., via a servo) by a controller (e.g., within the cameras 902, 906 or exterior thereto, such as the controller 806, FIG. 8 or the controller 326, FIG. 3) in such a way that the image of the travelling block 304 appears the same size and position as the image central video camera 904. Using a triangulation technique, the distance between the video camera 904 and the travelling block 304 may be computed.

In an embodiment, the use of multiple side cameras 902, 906 may account for line-of-sight issues, e.g., to overcome potential challenges in acquiring an image due to other structures being between the cameras 902, 906 and the travelling block 304, as the travelling block 304 moves.

Further, in an embodiment, the centrally-placed camera 904 may be manipulated along a perpendicular plane to the crown block 316 (see FIG. 9). The perpendicular manipulation may account for compression and flexing of the rig structure 318 (e.g., the mast) caused by the hookload. The horizontal manipulation along the crown block 316 by the other cameras 902, 906 may allow the cameras 902, 906 to maintain the block image in their field of view as the travelling block 304 moves away or towards the crown block 316. Thus, making the other cameras 902, 906 acquire an image that matches the position and size of the image acquired by the central camera 904 may facilitate controlling such a triangulation technique.

For example, an angle in the perpendicular plane by which the central camera 904 pivots to keep the travelling block 304 in view may be recorded. Along with a knowledge of the distance between the travelling block 304 and the camera 904, this angle may be employed in a calculation of the amount of flexing of the rig structure 318. In some embodiments, the flexing amount may be on the order of several inches or more. Such a camera-based, flex determination may be combined with other embodiments of the present disclosure, e.g., to calibrate or correct for such deformation in the rig structure 318.

It will be appreciated that several variations of this triangulation embodiment may be employed. For example, the distance between the cameras 902 and 904 and between the cameras 904 and 906 may be different, resulting in the angles x and y for the two cameras 902, 906 being different as the travelling block 304 moves. Further, in at least one embodiment, a single side camera (e.g., the camera 902) may be employed, and the second side camera (e.g., the camera 904) and/or the central camera 904 may be omitted.

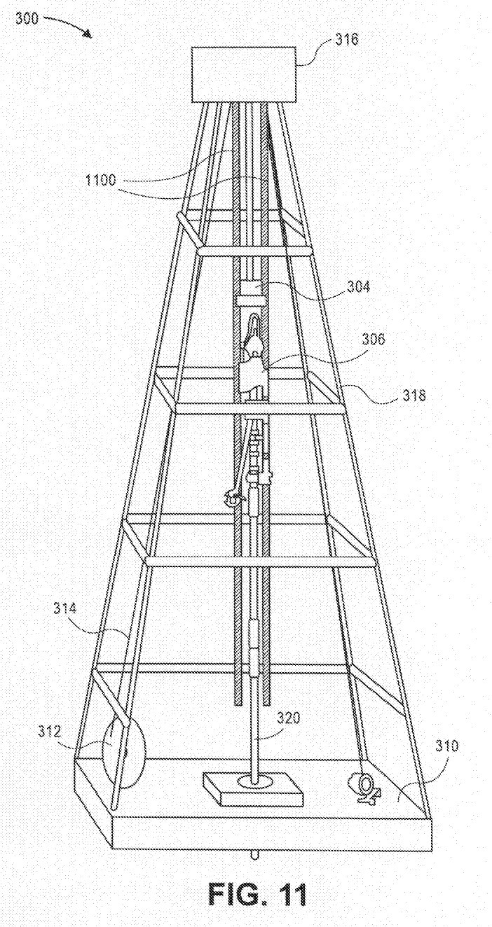

FIG. 11 illustrates a perspective view of the drilling rig 300, according to yet another embodiment. The drilling rig 300 may include one or more guide rails 1100 (two are shown). The guide rails 1100 may extend along a range of motion of the travelling block 304 and drilling device 306, e.g., vertically above the rig floor 310. In an embodiment, the travelling block 304 and/or the drilling device 306 may include rollers or other guide elements which may ride along the guide rails 1100, e.g., to maintain an accurate positioning of the drilling device 306 and thus the tubular string 320 attached thereto. For example, the guide rails 1100 may be attached to and hang down from the crown block 316, may be attached to the mast (not visible), may extend upward from and be connected to the rig floor 310.

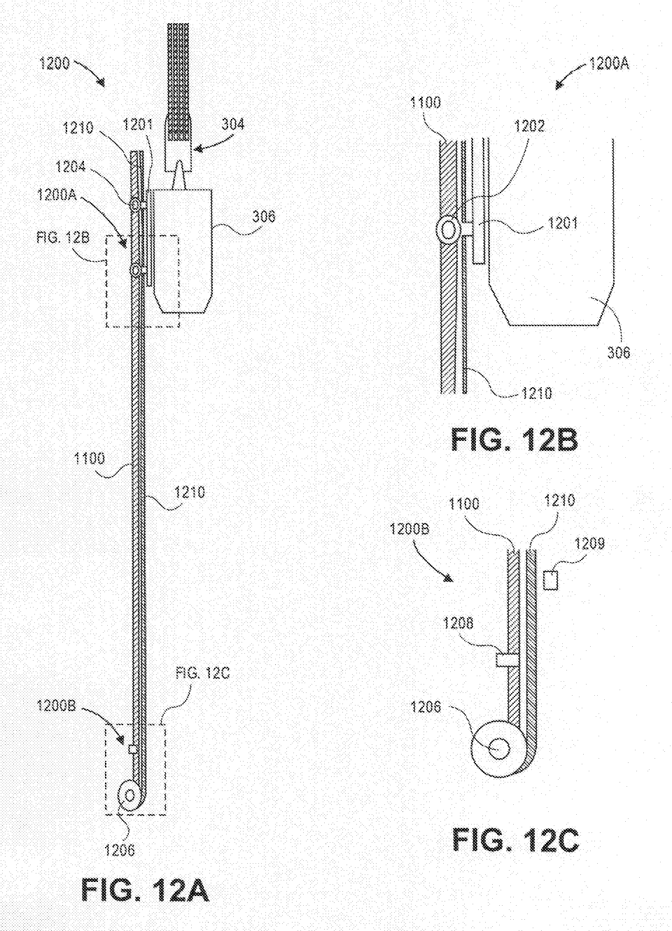

With continuing reference to FIG. 11, FIG. 12A illustrates a schematic view of one of the guide rails 1100 and another elevation depth measurement system 1200 (hereinafter, “the system 1200”), according to an embodiment. The system 1200 may include a first assembly 1200A and a second assembly 1200B, which may be configured to generate an acoustic signal from which an elevation of the drilling device 306 (and/or the travelling block 304) may be calculated.

With continuing reference to FIG. 12A, FIG. 12B illustrates an enlarged view of a portion of FIG. 12A, as indicated therein, showing the first assembly 1200A in greater detail, according to an embodiment. For example, the first assembly 1200A may include a dolly 1201 coupled to the drilling device 306. As noted above, the drilling device 306 may ride along the guide rail 1100, e.g., up and down with respect to the rig floor 310 along the axis 1004 (FIG. 10), as the travelling block 304 is moved by the drawworks 312 (FIG. 10). The dolly 1201 may provide the coupling between the drilling device 306 and the guide rail 1100. For example, the dolly 1201 may include one or more rollers (two shown: 1202, 1204) that ride on the guide rails 1100.

With continuing reference to FIG. 12A, FIG. 12C illustrates an enlarged view of another portion of FIG. 12A, as also indicated therein, showing the second assembly 1200B in greater detail, according to an embodiment. The second assembly 1200B may be spaced apart from the first assembly 1200A along the guide rail 1100. For example, the second assembly 1200B may be positioned at a lower end of the guide rail 1100, e.g. proximal to the rig floor 310. In other example, the second assembly 1200B may be positioned at another location.

The second assembly 1200B may include a drum 1206, a striker 1208, a pickup 1209, and an instrumented pin 1211. A line 1210, such as a slickline, may extend between the first and second assemblies 1200A, 1200B. An end of the line 1210 may be wrapped around the drum 1206, while an opposite end of the line 1210 may be attached to the first assembly 1200A (e.g., the dolly 1201), the crown block 316, or to another structure above the dolly 1201. Rotation of the drum 1206 may draw in or let out the line 1210. Further, the drum 1206 may be configured to maintain a generally constant tension in the line 1210, e.g., to account for compression forces on the rig structure 318, thermal expansion, and the like. For example, rotation of the drum 1206 may be computer-controlled via a stepper motor, spring biased, etc., so as to apply such generally constant tension.

The striker 1208 may be a hammer or another type of implement, which may apply an impulsive force to the line 1210, thereby generating a vibration in the line 1210. The dolly 1201, on the other end of the line 1210, may pinch the line 1210 so as to pinch off, in an acoustic sense, the line 1210. In another embodiment, the line 1210 may move with the dolly 1201, and the drum 1206 may be employed to maintain a constant tension, such that the line 1210 between the first and second assemblies 1200A, 1200B is shortened when the dolly 1201 moves closer to the drum 1206. In some embodiments, the striker 1208 may be positioned at another location along the line 1210, which may not be in close proximity to the drum 1206.

The instrumented pin 1211 may measure the tension in the line 1210. The drum 1206 may be adjusted in response to this feedback, so as to maintain a generally constant tension in the line 1210.

The pickup 1209, which may provide the detector in this embodiment, may be configured to detect a lateral movement, e.g., vibration induced by the striker 1208, in the line 1210. The frequency of the movement in the line 1210 may be harmonic, and thus may be proportional to the length of the line 1210 between the drum 1206 and where the dolly 1201 pinches off, or is connected to, the line 1210. The pulses generated by the pickup 1209 may be readily converted into frequency information, which may be employed to determine a length of the line 1210. As the drum 1206 may have a fixed elevation, a determination of the length of the line 1210 may allow for a calculation of the elevation of the dolly 1201. Since distance between the dolly 1201, the drilling device 306, and the travelling block 304 may be generally fixed, a knowledge of the location of the dolly 1201 may thus allow for a calculation of either or both of the other two components.

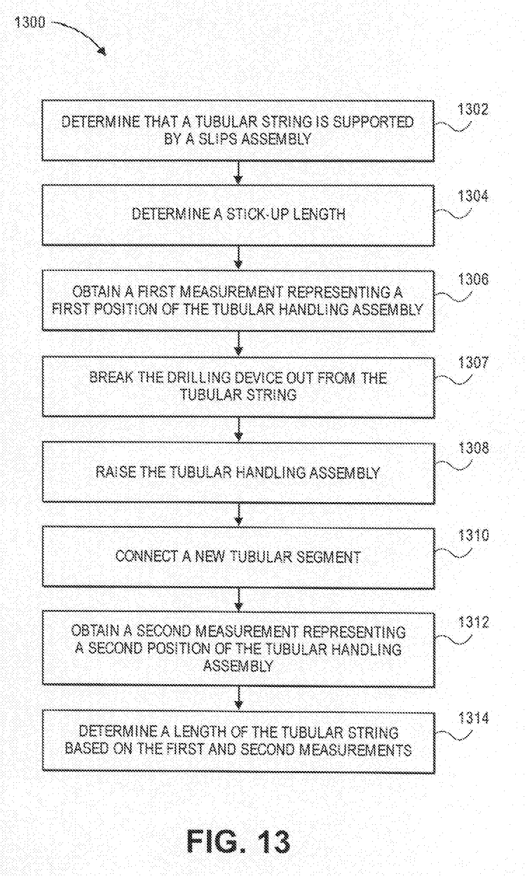

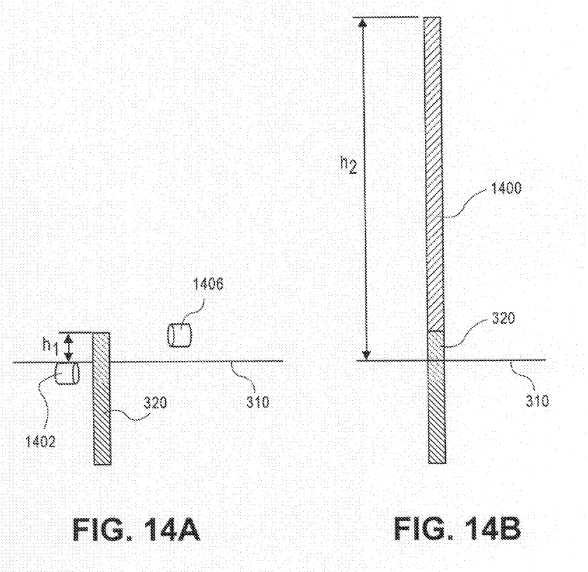

FIG. 13 illustrates a flowchart of a method 1300 for measuring a length of a tubular string deployed into a well, according to an embodiment. FIGS. 14A and 14B illustrate simplified schematic views of tubular string 320 and a new stand 1400 during an execution of the method 1300, according to an embodiment. The method 1300 may proceed by operation of one or more embodiments of the drilling rig 300 and/or the above-described elevation measurement systems, and is thus described herein with reference thereto. However, the method 1300 may, in some embodiments, be executed by using other structures.

The method 1300 may begin with the drilling device 306 supporting the tubular string 320, e.g., during a drilling operation, and lowering the tubular string 320 through the slips assembly 308, until the slips assembly 308 engages the tubular string 320. The method 1300 may then include determining that the tubular string 320 is supported by the slips assembly 308, as at 1302. This determination may be conducted using a slip detection device 1400, e.g., including a camera configured to detect slippage using a pattern recognition algorithm based on landmarks in the string 320 itself. For example, when the tubular string 320 is securely supported by the slips assembly 308, there may be no change in the pattern of landmarks on the tubular string 320 detected by the device 1402.

Once the string 320 is supported by the slips assembly 308, the method 1300 may include obtaining a “stick-up” length hl, as at 1304, which may be the distance above the rig floor 310 that the string 320 extends while in slips. In an embodiment, a sensor 1406, disposed proximal to or at the rig floor 1310 may be employed to determine the stick-up length hl. The sensor 1406 may be a camera, for example.

Before, during, or after obtaining the stick-up length at 1306, the method 1300 may include obtaining a measurement (e.g., elevation) of a first position of the tubular handling assembly (e.g. travelling block 304 or drilling device 306), as at 1306. Such measurement may be taken using the elevation measurement system 302 and/or 700, according to any one or more of the above-described embodiments. The first measurement of the tubular handling assembly (e.g. travelling block 304) may be correlated with the stick-up length hl, as at 1306.

The method 1300 may proceed to breaking the drilling device 306 out from the tubular string 320, as at 1307. This may occur, for example, by disconnecting a quill shaft of the drilling device 306 from an upper or “box” end of the tubular string 320. Disconnecting the drilling device 306 from the tubular string 320 may result in the drilling device 306 being raised slightly, as the threads of the quill shaft are backed out of engagement with the threads of the tubular string 320. The travelling block 304 may be raised along with the drilling device 306 during such disconnection. The raising of the travelling block 304 and/or the drilling device 306 during the disconnection may be measured externally (e.g., using a camera) or may be measured internally in the drilling device 306. The travelling block 304 may then be moved, e.g., raised, as at 1308. For example, the travelling block 304 may be raised to an elevation sufficient to accept a new stand 1400 between the drilling device 306 and the top of the tubular string 320 supported in the slips assembly 308, and the new stand 1402 may be connected to the drilling device 306 and the tubular string 320, as at 1310, so as to become part of the tubular string 320. This may be the positioned illustrated in FIG. 14B.

As the travelling block 304 is raised, the elevation measurement system may continuously acquire, or be configured to continuously acquire, an elevation measurement for the travelling block 304, or another part of the drilling device. Such “continuous” acquisition may be achieved by taking multiple, close-together measurements of markers (such as the embodiments of FIGS. 4 and 6) or recognizing pulses (such as generated by the teeth 500 of FIG. 5). Continuous acquisition of elevation may also be achieved using the adjustable lens, triangulation, acoustic pick-up, etc., as described above. Such embodiments may be capable of determining the elevation of the drilling device without relying on pre-determined marker elevations and thus, while the measurements may, in some embodiments, not actually be determined on a continuous basis, but rather may be detected at set intervals or on demand, the elevation measurement systems may remain capable of making such continuous acquisitions.

As also shown in FIG. 14B, once the new stand 1400 is connected to and becomes part of the tubular string 320, the method 1300 may include obtaining a second measurement representing a second position (elevation) of the tubular handling assembly (e.g., the travelling block 304 and/or the drilling device 306), as at 1312.

The method 1300 may then include determining a length of the tubular string 320 based at least partially on the first and second measurements, as at 1314. Assuming there is substantially no slippage in the system after the new stand 1400 is connected to the tubular string 320, since the precise block position and stick-up length is determined, the length that the new stand 1400 adds to the tubular string 320 may be equal to the difference between the first and second positions. For example, the second elevation minus the first elevation may equal the length of the tubular string 320 added by the new stand 1402. Accordingly, a previously-calculated length of the tubular string 320, prior to adding the new stand 1402, may be incremented by the length added by the new stand 1402, resulting in an accurate determination of the new length of the tubular string 320.

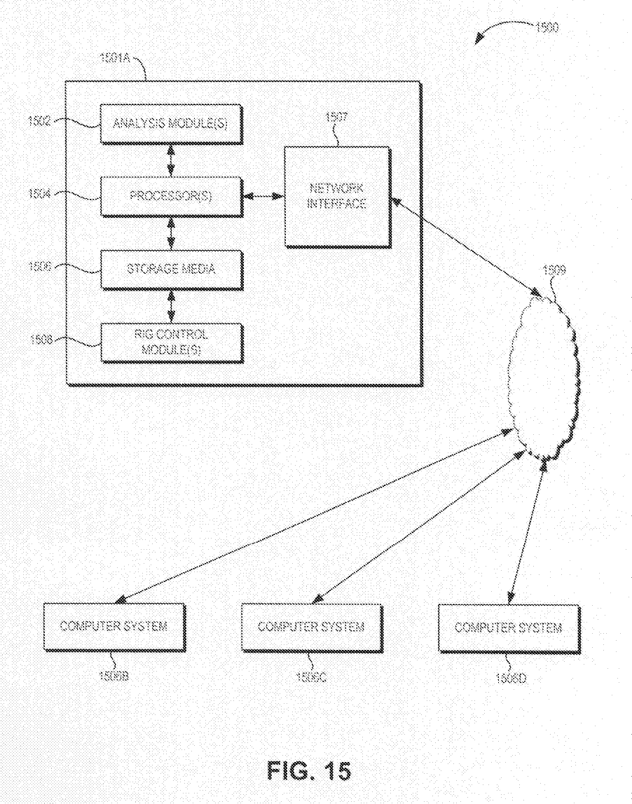

In some embodiments, the methods of the present disclosure may be executed by a computing system. FIG. 15 illustrates an example of such a computing system 1500, in accordance with some embodiments. The computing system 1500 may include a computer or computer system 1501A, which may be an individual computer system 1501A or an arrangement of distributed computer systems. The computer system 1501A includes one or more analysis modules 1502 that are configured to perform various tasks according to some embodiments, such as one or more methods disclosed herein. To perform these various tasks, the analysis module 1502 executes independently, or in coordination with, one or more processors 1504, which is (or are) connected to one or more storage media 1506. The processor(s) 1504 is (or are) also connected to a network interface 15015 to allow the computer system 1501A to communicate over a data network 1509 with one or more additional computer systems and/or computing systems, such as 1501B, 1501C, and/or 1501D (note that computer systems 1501B, 1501C and/or 1501D may or may not share the same architecture as computer system 1501A, and may be located in different physical locations, e.g., computer systems 1501A and 1501B may be located in a processing facility, while in communication with one or more computer systems such as 1501C and/or 1501D that are located in one or more data centers, and/or located in varying countries on different continents).

A processor may include a microprocessor, microcontroller, processor module or subsystem, programmable integrated circuit, programmable gate array, or another control or computing device.

The storage media 1506 may be implemented as one or more computer-readable or machine-readable storage media. Note that while in the example embodiment of FIG. 15 storage media 1506 is depicted as within computer system 1501A, in some embodiments, storage media 1506 may be distributed within and/or across multiple internal and/or external enclosures of computing system 1501A and/or additional computing systems. Storage media 1506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURRY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 1500 contains one or more sensor control module(s) 1508. In the example of computing system 1500, computer system 1501A includes the sensor control module 1508. In some embodiments, a single sensor control module may be used to perform some or all aspects of one or more embodiments of the methods disclosed herein. In alternate embodiments, a plurality of sensor control modules may be used to perform some or all aspects of methods herein.

It should be appreciated that computing system 1500 is only one example of a computing system, and that computing system 1500 may have more or fewer components than shown, may combine additional components not depicted in the example embodiment of FIG. 15, and/or computing system 1500 may have a different configuration or arrangement of the components depicted in FIG. 15. The various components shown in FIG. 15 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A method, comprising:
obtaining a first measurement of a first position of a tubular handling assembly using a detector;
moving the tubular handling assembly after obtaining the first measurement, wherein the detector is configured to continuously detect a current position of the at least a portion of the tubular handling assembly while moving the tubular handling assembly;
obtaining a second measurement of a second position of the tubular handling assembly using the detector; and
determining a length of a tubular string based partially on a difference between the first and second positions.

2. The method of claim 1, wherein the tubular handling assembly comprises a travelling block and a drilling device, wherein the first positioned is determined based on an elevation of the travelling block, the drilling device, or both, and wherein the second position is determined based on the elevation of the travelling block, the drilling device, or both.

3. The method of claim 1, further comprising continuously obtaining measurements of the current position of the at least a portion of the tubular handling assembly while moving the at least a portion of the tubular handling assembly.

4. The method of claim 1, further comprising connecting a tubular segment to the tubular handling assembly and to the tubular string after moving the tubular handling assembly, wherein obtaining the second measurement is performed after connecting the tubular segment to the tubular handling assembly and the tubular string.

5. The method of claim 1, wherein determining the length of the tubular string comprises adding a difference between the first measurement and the second measurement to a previously-calculated length of the tubular string.

6. The method of claim 1, wherein:
obtaining the first measurement comprises measuring a first elevation of the at least a portion of the tubular handling assembly when the tubular handling assembly is in the first position; and
obtaining the second measurement comprises measuring a second elevation of the at least a portion of the tubular handling assembly when the tubular handling assembly is in the second position.

7. The method of claim 1, wherein moving the tubular handling assembly comprises raising the detector, the detector being coupled to the tubular handling assembly and configured to move therewith.

8. The method of claim 7, wherein measuring the second position comprises detecting one or more stationary markers while moving the tubular handling assembly after measuring the first position.

9. The method of claim 8, wherein detecting the one or more markers comprises counting a number of the one or more markers between the first and second positions.

10. The method of claim 1, wherein:
obtaining the first measurement comprises identifying a first marker of the one or more markers based on a size, shape, color, or combination thereof of the first marker, using the detector; and
obtaining the second measurement comprises identifying a second marker of the one or more markers based on a size, shape, color, or combination thereof of the second marker, using the detector, the first and second markers being disposed at different, predetermined elevations.

11. The method of claim 1, wherein:
the detector comprises an image sensor and a lens, a distance between the image sensor and the lens being adjustable;
obtaining the first measurement comprises determining a first distance between the lens and the image sensor at which an image of at least a portion of the tubular handling assembly is in focus;
obtaining the second measurement comprises determining a second distance between the lens and the image sensor at which the image of the at least a portion of the tubular handling assembly is in focus; and
determining the length of the tubular string comprises determining an elevation between the first and second positions based on a difference between the first and second distances.

12. The method of claim 1, wherein:
the detector comprises an image sensor and a lens, a distance between the image sensor and the lens being adjustable;
obtaining the first measurement comprises determining a first distance between the lens and the image sensor at which an image of at least a part of the tubular handling assembly has a size;
obtaining the second measurement comprises determining a second distance between the lens and the image sensor at which the image of the at least a part of the tubular handling assembly has a size that is substantially the same as the size of the image used in obtaining the first measurement; and
determining the length of the tubular string comprises determining an elevation between the first and second positions based on a difference between the first and second distances.

13. The method of claim 1, wherein:
obtaining the first measurement comprises determining a first angle defined by an orientation of a camera and a reference plane that is normal to an axis along which the tubular handling assembly is moved, wherein the camera is oriented toward the tubular handling assembly in the first position and is offset from the axis along the reference plane;
obtaining the second measurement comprises determining a second angle defined by the orientation of the camera and the reference plane; and
determining the length of the tubular string comprises determining an elevation difference between the first and second positions based on the first and second angles.

14. The method of claim 1, wherein:
obtaining the first measurement comprises measuring a first vibration frequency in a line coupled to or engaged with the tubular handing assembly when the tubular handling assembly is in the first position;
obtaining the second measurement comprises measuring a second vibration frequency in the line when the tubular handling assembly is in the second position; and
determining the length comprises comparing the first and second vibration frequencies.

15. The method of claim 14, further comprising:
maintaining a generally constant tension in the line as the tubular handling assembly is moved; and
changing a length along which a vibration in the line propagates, by moving the tubular handling assembly.

16. The method of claim 1, wherein the tubular handling assembly comprises a travelling block coupled to a drawworks via a drill line, and wherein moving the tubular handling assembly comprises rotating the drawworks.

17. The method of claim 1, further comprising:
determining a stick-up length of the tubular string using a second detector, when the tubular string is supported by a slips assembly; and
correlating the first position of the tubular handling assembly with the stick-up length.

18. The method of claim 1, further comprising determining a deformation of a rig structure supporting the tubular string and the tubular handling assembly using the detector.

19. An elevation measurement system for a drilling rig, comprising:
a tubular handling assembly comprising a drilling device that is movable along an axis and connectable to a tubular; and
a detector coupled to the tubular handling assembly or to the drilling rig, the detector being configured to continuously determine a position or a position change of the tubular handling assembly.

20. The elevation measurement system of claim 19, further comprising one or more markers disposed at one or more predetermined positions and coupled to a stationary rig structure, wherein the detector is configured to identify the one or more markers and to determine the position of the detector, or the position change thereof, based on identifying the one or more markers.

21. The elevation measurement system of claim 20, wherein the one or more markers comprise a plurality of markers, each of the plurality of markers having a unique identifier, the unique identifier comprising a color-coding, shape, or a combination thereof.

22. The elevation measurement system of claim 19, wherein the detector comprises an image sensor and a lens, a distance between the image sensor and the lens being variable, such that the detector is configured to determine the position or the position change of at least a portion of the tubular handling assembly based on the distance between the image sensor and the lens.

23. The elevation measurement system of claim 19, wherein the detector comprises a camera that is offset along a reference axis that is normal to the axis along which the tubular handling assembly is movable, from the axis along which the tubular handling assembly is movable, the camera being configured to change orientation to maintain at least a part of the tubular handling assembly within a field of view, and wherein the detector is configured to determine the position or the position change based on a change in an angle defined between the orientation of the camera and the reference axis.

24. The elevation measurement system of claim 19, wherein further comprising a line coupled to the drilling device, wherein a length along which a vibration wave propagates along the line changes by moving the drilling device along the axis, and wherein the detector comprises an electronic pickup that measures a frequency of vibration in the line.
